(19) United States
(12) Patent Application Publication
(10) Pub. No.: US 2014/0009072 A1
(43) Pub. Date: Jan. 9, 2014

(54) LIGHT EMITTING SYSTEM AND POWER CONTROL DEVICE THEREOF

(71) Applicant: NATIONAL CHI NAN UNIVERSITY, Puli (TW)

(72) Inventors: Tai-Ping SUN, Jhongli City (TW); Hsiu-Li SHIEH, Taichung City (TW); Kuo-Sheng CHAO, Puli (TW)

(73) Assignee: NATIONAL CHI NAN UNIVERSITY, Puli (TW)

(21) Appl. No.: 13/733,484

(22) Filed: Jan. 3, 2013

(30) Foreign Application Priority Data
Jul. 6, 2012 (TW) 101124417

(51) Int. Cl. H05B 37/02

(52) U.S. Cl. CPC H05B 37/02
USPC 315/158

(57) ABSTRACT

A light emitting system includes a light emitting device having a forward voltage dependent on an ambient parameter, and a power control device including a current generator, a compensation voltage module, and a control signal generator. The current generator converts a control signal into a driving current for provision to the light emitting device, and provides a feedback voltage. The compensation voltage module obtains a compensation voltage according to the forward voltage, the feedback voltage, and a reference voltage. The control signal generator generates the control signal according to the compensation voltage for provision to the current generator.

### CROSS-REFERENCE TO RELATED APPLICATION

This application claims priority to Taiwanese Application No. 101124417, filed on Jul. 6, 2012.

### BACKGROUND OF THE INVENTION

1. Field of the Invention

The invention relates to a light emitting system and a power control device thereof.

2. Description of the Related Art

FIG. 1 shows a conventional power control device adapted to receive a direct-current input voltage Vin and generate a working current to drive a light-emitting diode (LED). When the input voltage Vin is constant, the working current has a constant magnitude.

However, the working current resulting from the direct-current input voltage Vin will increase temperature of the LED, and characteristics of the LED vary with ambient temperature. Referring to FIG. 2, a forward voltage of the LED varies with ambient temperature, and LEDs with different primary colors (i.e., red, green, and blue) follow different forward voltage-temperature curves. When the LED is driven with a constant current, rise of the ambient temperature may result in drop of the forward voltage, so that the output power of the LED (=forward voltage×working current) drops with rise of the ambient temperature.

In application, several LEDs with different primary colors are frequently used together to obtain light with a desired color temperature and a desired color rendering index. When each of the LEDs with different primary colors is driven by a corresponding conventional power control device, the power ratio thereamong may drift due to different drop levels among the LEDs, such that the desired color temperature and the desired color rendering index may not be maintained.

### SUMMARY OF THE INVENTION

Therefore, an object of the present invention is to provide a light emitting system that may have a relatively stable color temperature and a relatively stable color rendering index.

According to one aspect of the present invention, a light emitting system comprises:

a light emitting device that has a forward voltage with a magnitude dependent on an ambient parameter when driven with current; and

a power control device including:
a current generator coupled to the light emitting device and disposed to receive a control signal, the current generator being operable to convert the control signal into a driving current provided to the light emitting device, the driving current being associated with a parameter of the control signal, the current generator being further operable to provide a feedback voltage dependent on the driving current;
a compensation voltage module coupled to the light emitting device for detecting the forward voltage of the light emitting device, coupled to the current generator for detecting the feedback voltage, and disposed to receive a reference voltage, the compensation voltage module being operable to obtain a compensation voltage according to the forward voltage, the feedback voltage, and the reference voltage; and

a control signal generator coupled to the compensation voltage module for receiving the compensation voltage, and coupled to the current generator, the control signal generator being operable to generate the control signal according to the compensation voltage for provision to the current generator, the parameter of the control signal being associated with the compensation voltage.

Another object of the present invention is to provide a power control device that may alleviate output power drop of a light emitting device.

According to another aspect of the present invention, a power control device is adapted to control a light emitting device that has a forward voltage with a magnitude dependent on an ambient parameter when driven with current, and comprises:

a current generator to be coupled to the light emitting device and disposed to receive a control signal, the current generator being operable to convert the control signal into a driving current to be provided to the light emitting device, the driving current being associated with a parameter of the control signal, the current generator being further operable to provide a feedback voltage dependent on the driving current;

a compensation voltage module to be coupled to the light emitting device for detecting the forward voltage of the light emitting device, coupled to the current generator for detecting the feedback voltage, and disposed to receive a reference voltage, the compensation voltage module being operable to obtain a compensation voltage according to the forward voltage, the feedback voltage, and the reference voltage; and

a control signal generator coupled to the compensation voltage module for receiving the compensation voltage, and coupled to the current generator, the control signal generator being operable to generate the control signal according to the compensation voltage for provision to the current generator, the parameter of the control signal being associated with the compensation voltage.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit diagram of a conventional power control device;

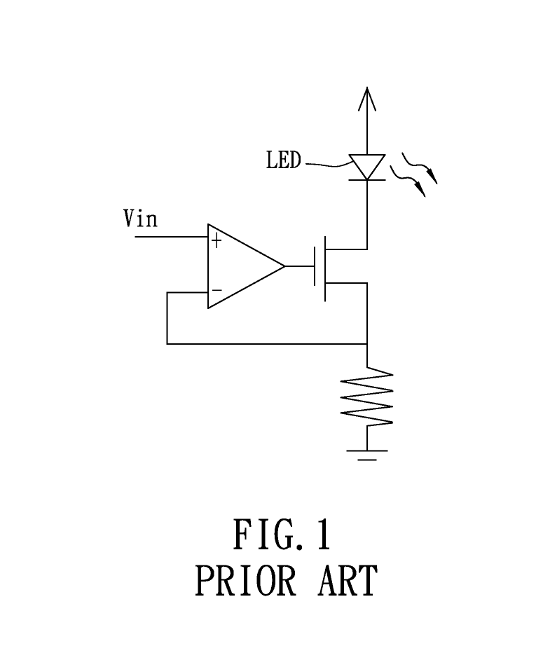

FIG. 2 is a plot illustrating relationships between ambient temperature and forward voltages of light emitting diodes with different primary colors;

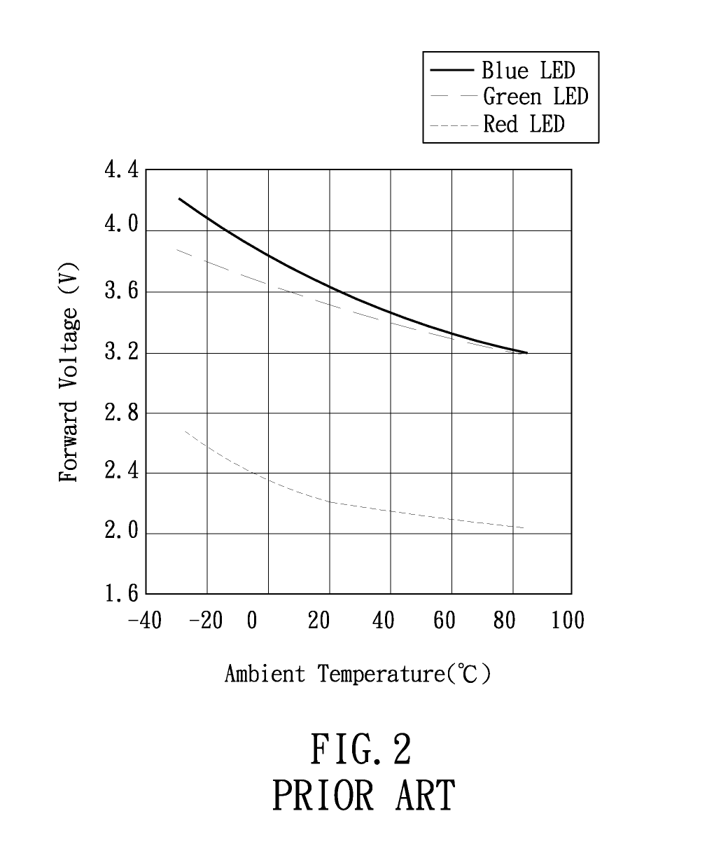

FIG. 3 is a schematic circuit diagram of a preferred embodiment of a light emitting system according to the present invention;

FIG. 4 is a schematic circuit diagram of a compensation voltage module of the preferred embodiment;

FIG. 5 is a plot illustrating generation of a control signal by a control signal generator of the preferred embodiment; and

FIG. 6 is a schematic circuit diagram of an application of the preferred embodiment.

### DETAILED DESCRIPTION OF THE PREFERRED EMBODIMENT

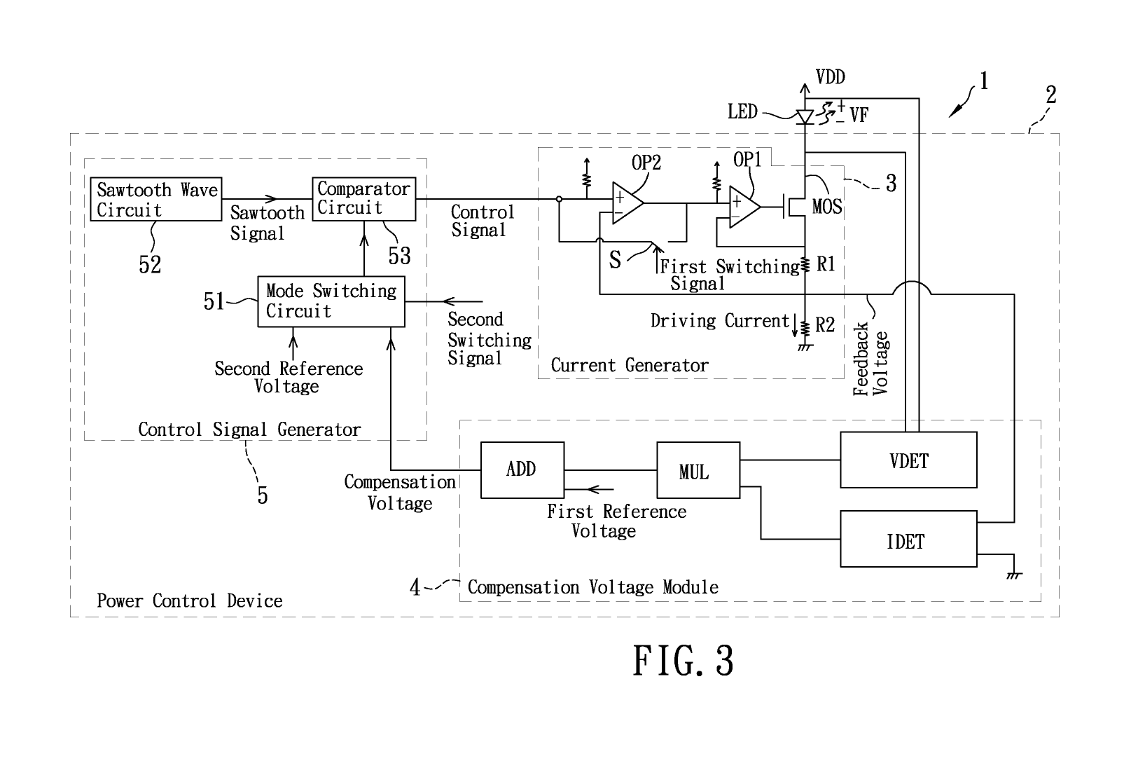

Referring to FIG. 3, the preferred embodiment of the light emitting system 1 according to this invention is shown to include a light emitting device LED and a power control device 2.

In this embodiment, the light emitting device LED is a light emitting diode device that has a forward voltage VF with a magnitude dependent on an ambient temperature (an ambient parameter) when driven with current, and that has an anode end for receiving a bias voltage VDD, and a cathode end.

The power control device 2 includes a current generator 3, a compensation voltage module 4, and a control signal generator 5.

The current generator 3 is coupled to the cathode end of the light emitting device LED and is disposed to receive a control signal. In this embodiment, the control signal is a pulse signal. The current generator 3 converts the control signal into a driving current (a pulse current) provided to the light emitting device LED. In this embodiment, the driving current has an average magnitude proportional to a duty cycle (a parameter) of the control signal. The current generator 3 is further operable to provide a feedback voltage that has a magnitude proportional to a magnitude of the driving current, i.e., the feedback voltage is dependent on the driving current. In this embodiment, the current generator 3 includes a bypass switch S, a first operational amplifier OP1, a transistor MOS, a first resistor R1, a second resistor R2, and a second operational amplifier OP2.

The bypass switch S includes a first terminal for receiving the control signal, a second terminal, and a third terminal for receiving a first switching signal to make or break electrical connection between the first and second terminals thereof according to the first switching signal.

The first operational amplifier OP1 has a non-inverting first input (+) coupled to the second terminal of the bypass switch S for receiving the control signal, an inverting second input (−), and an output.

The transistor MOS has a first terminal coupled to the cathode end of the light emitting device LED, a second terminal coupled to the second input (−) of the first operational amplifier OP1, and a control terminal coupled to the output of the first operational amplifier OP1.

The first resistor R1 has a first terminal coupled to the second input (−) of the first operational amplifier OP1, and a second terminal.

The second resistor R2 has a first terminal coupled to the second terminal of the first resistor R1, and a grounded second terminal. The feedback voltage has a magnitude that is substantially equal to a product of the magnitude of the driving current and a resistance of the second resistor R2 in this embodiment.

The second operational amplifier OP2 has a non-inverting first terminal (+) coupled to the first terminal of the bypass switch S, an inverting second terminal (−) coupled to the second terminal of the first resistor R1, and an output coupled to the first terminal (+) of the first operational amplifier OP1.

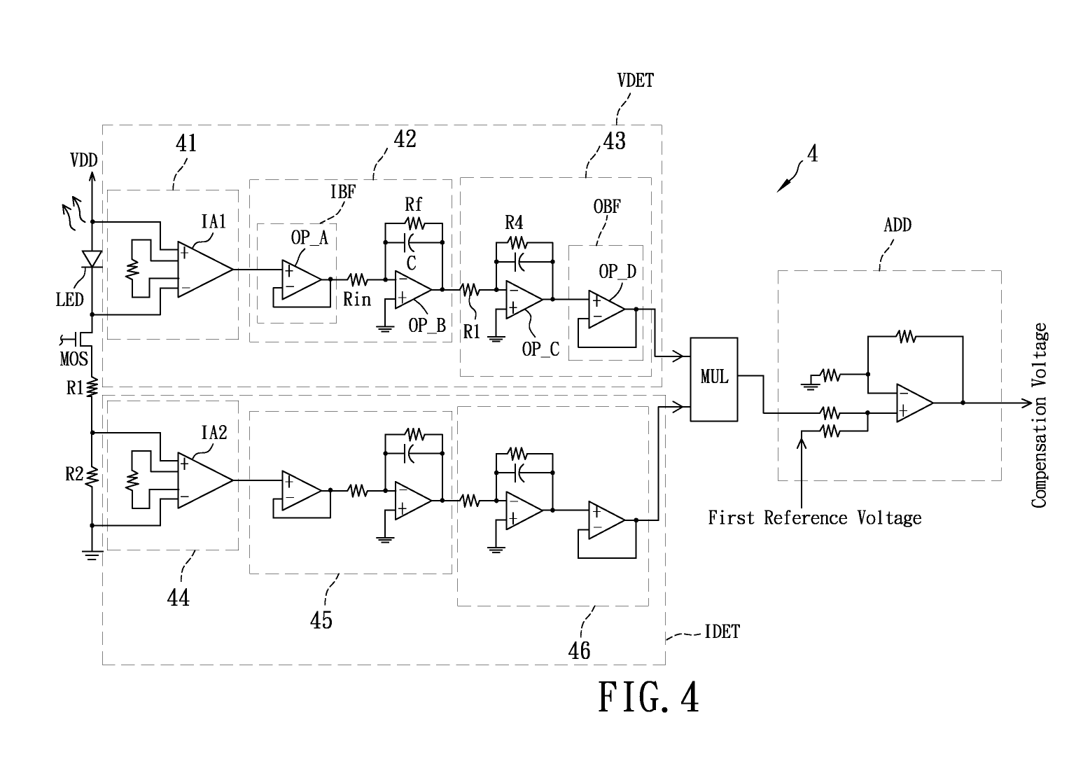

Referring to FIGS. 3 and 4, the compensation voltage module 4 is coupled to the cathode end and the anode end of the light emitting device LED for detecting the forward voltage VF of the light emitting device LED, is coupled to the current generator 3 for detecting the feedback voltage, and is disposed to receive a first reference voltage. The compensation voltage module 4 is operable to obtain a compensation voltage according to the forward voltage VF, the feedback voltage, and the first reference voltage. In this embodiment, the compensation voltage has a magnitude proportional to the magnitude variation of the forward voltage VF. The compensation voltage module 4 includes a voltage detecting unit VDET, a current detecting unit IDET, a multiplier unit MUL, and an adder unit ADD.

The voltage detecting unit VDET is coupled to the light emitting device LED for detecting the forward voltage VF thereof, so as to obtain a first working voltage proportional to the forward voltage VF. In this embodiment, the voltage detecting unit VDET includes a voltage detector circuit 41, a voltage integrator circuit 42, and a first amplifier circuit 43.

The voltage detector circuit 41 includes an instrumentation amplifier IA1 that has a non-inverting first input (+) coupled to the anode end of the light emitting device LED, an inverting second input (−) coupled to the cathode end of the light emitting device LED, and an output for providing a first output response that is proportional to the forward voltage VF of the light emitting device LED.

The voltage integrator circuit 42 is coupled to the voltage detector circuit 41 for receiving and performing integration operation on the first output response, so as to obtain an integration voltage. The voltage integrator circuit 42 includes an input buffer IBF, an operational amplifier OP_B, an input resistor Rin, a capacitor C, and a feedback resistor Rf.

The input buffer IBF is used for increasing input impedance and for transferring the first output response from the voltage detector circuit 41, and includes an operational amplifier OP_A. The operational amplifier OP_A has a non-inverting first input (+) coupled to the output of the instrumentation amplifier IA1 for receiving the first output response, an inverting second input (−), and an output that is coupled to the inverting second input (−) thereof, and that provides a transferred first output response according to the first output response from the voltage detector circuit 41.

The operational amplifier OP_B has a grounded non-inverting first input (+), an inverting second input (−), and an output for providing the integration voltage. The input resistor Rin is coupled between the output of the operational amplifier OP_A and the inverting second input (−) of the operational amplifier OP_B. The capacitor C is coupled between the inverting second input (−) and the output of the operational amplifier OP_B. The feedback resistor Rf and the capacitor C are connected in parallel.

The first amplifier circuit 43 is coupled to the voltage integrator circuit 42 for receiving and amplifying the integration voltage, so as to obtain the first working voltage. In application, since red, green, and blue LEDs correspond to different forward voltage-temperature curves, the gains of the first amplifier circuit 43 of the corresponding power control devices 2 may be designed to be different. The first amplifier circuit 43 includes an operational amplifier OP_C, a third resistor R3, a fourth resistor R4, and an output buffer OBF.

The third resistor R3 has a first terminal for receiving the integration voltage, and a second terminal. The operational amplifier OP_C has a grounded non-inverting first input (+), an inverting second input (−) coupled to the second terminal of the third resistor R3, and an output for providing the first working voltage. The fourth resistor R4 has a first terminal coupled to the second terminal of the third resistor R3, and a second terminal coupled to the output of the operational amplifier OP_C.

The output buffer OBF is used for increasing output impedance of the first amplifier circuit 43, and is coupled to the output of the operational amplifier OP_C for receiving and transferring the first working voltage. The output buffer OBF includes an operational amplifier OP_D that has a non-inverting first input (+) coupled to the output of the operational amplifier OP_C for receiving the first working voltage, an inverting second input (−), and an output that is coupled to the inverting second input (−) thereof and that provides a transferred first working voltage according to the first working voltage.

The current detecting unit IDET is coupled to the current generator 3 for detecting the feedback voltage, so as to obtain a second working voltage proportional to the average magnitude of the driving current. In this embodiment, the current detecting unit IDET includes a current detector circuit 44, a current integrator circuit 45, and a second amplifier circuit 46.

The current detector circuit 44 is used for obtaining a differential-mode component of the feedback voltage, and for filtering out a common-mode direct-current level of the feedback voltage. The current detector circuit 44 includes an instrumentation amplifier IA2 having a non-inverting first input (+) coupled to the first terminal of the second resistor R2 of the current generator 3, a grounded inverting second input (−), and an output for providing a second output response associated with the feedback voltage.

Since the current integrator circuit 45 and the second amplifier circuit 46 of the current detecting unit IDET have the same configurations as the voltage integrator circuit 42 and the first amplifier circuit 43 of the voltage detecting unit VDET, respectively, details thereof are not repeated herein. The second amplifier circuit 46 thus provides a transferred second working voltage from an output buffer of the second amplifier circuit 46.

The multiplier unit MUL is coupled to the voltage detecting unit VDET for receiving the transferred first working voltage, and is coupled to the current detecting unit IDET for receiving the transferred second working voltage. The multiplier unit MUL is operable to perform multiplication operation between the transferred first and second working voltages, so as to obtain a product voltage which represents an output power variation of the light emitting device LED.

The adder unit ADD is coupled to the multiplier unit MUL for receiving the product voltage, receives the first reference voltage, and performs addition operation between the product voltage and the first reference voltage, so as to obtain the compensation voltage.

The control signal generator 5 is coupled to the compensation voltage module 4 for receiving the compensation voltage, and is coupled to the current generator 3. The control signal generator 5 is operable to generate the control signal according to the compensation voltage for provision to the current generator 3. In this embodiment, the duty cycle of the control signal is inversely proportional to the magnitude of the compensation voltage. Therefore, the design of this embodiment establishes relationships of: rise in the ambient temperature→drop in the forward voltage→drop in output power of the light emitting device LED→drop in the compensation voltage→increase in the duty cycle of the control signal→increase in the average magnitude of the driving current→increase in output power of the light emitting device LED, so as to achieve a real-time tracking of the ambient temperature for maintaining the output power of the light emitting device LED.

In this embodiment, the control signal generator 5 includes a mode switching circuit 51, a sawtooth wave circuit 52, and a comparator circuit 53.

The mode switching circuit 51 receives a second reference voltage and the compensation voltage, and is responsive to a second switching signal to select the second reference voltage or the compensation voltage as an output thereof.

The sawtooth wave circuit 52 is adapted for generation of a sawtooth signal.

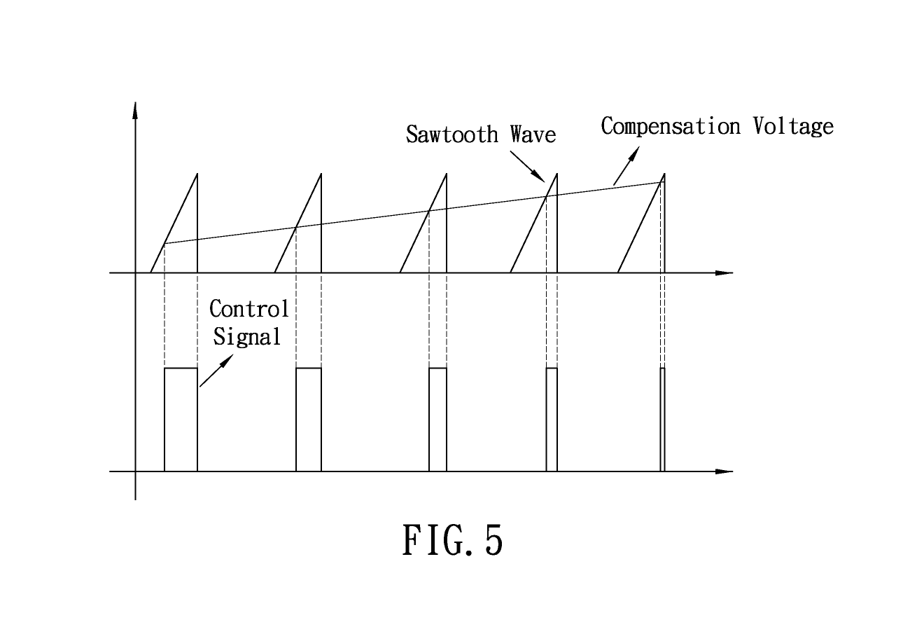

The comparator circuit 53 is coupled to the sawtooth wave circuit 52 for receiving the sawtooth signal, and is coupled to the mode switching circuit 51 for receiving the second reference voltage or the compensation voltage from the compensation voltage module 4 according to selection of the mode switching circuit 51. When the mode switching circuit 51 selects the compensation voltage as the output thereof, the comparator circuit 53 generates the control signal according to comparison of the compensation voltage and the sawtooth signal, such that the duty cycle of the control signal has an inverse relation to a magnitude of the compensation voltage, as shown in FIG. 5.

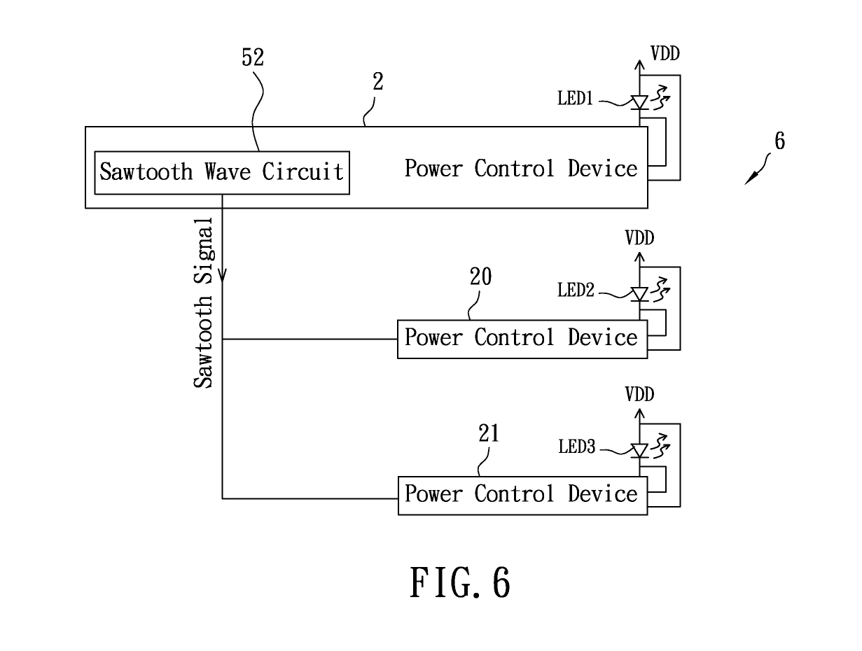

Referring to FIG. 6, an application of the light emitting system is a light-mixing control system 6 with high color rendering index, which includes a white light emitting diode LED1, a red light emitting diode LED2, a blue light emitting diode LED3, and three power control devices 2, 20, and 21.

The power control devices 2, 20, 21 are used to drive respectively the white light emitting diode LED1, the red light emitting diode LED2, and the blue light emitting diode LED3, and to control the duty cycles of the respective control signals with different compensation voltages, so as to maintain the color rendering index and the color temperature by independent control of the output power of the respective one of the LEDs 1˜3.

The architecture of the power control device 2 is the same as that described hereinabove. Each of the other two power control devices 20, 21 is similar to the power control device 2, and the only difference resides in that the sawtooth wave circuit 52 is not included therein. It should be noted that, in this application, the power control devices 20, 21 share the sawtooth wave circuit 52 of the power control device 2 and receive the sawtooth signal therefrom.

To sum up, the aforementioned application using the power control device 2 according to this invention has the following advantages:

1. Temperature increment of the LED is relatively small. The LED is driven by the driving current, which is a pulse current, such that the LED emits light in an active duration and dissipates heat in an inactive duration, resulting in a relatively small temperature increment. For example, when the duty cycle is 0.1, the LED emits light for one-tenth of a cycle time, and dissipates heat for the other nine-tenths of the cycle time.

2. The output power of the LED is maintained to be stable. The compensation voltage module 4 detects and feeds back the output power variation resulting from the ambient temperature variation, so that the duty cycle of the control signal is adjusted for enabling the LED to operate with stable output power.

3. The color temperature and the color rendering index of the resulting mixed light is relatively stable. Since the corresponding duty cycles of the LEDs 1-3 are controlled by different compensation voltages, respectively, the output power of each of the LEDs 1-3 is maintained independently, resulting in the relatively stable color temperature and color rendering index.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light emitting system comprising:
a light emitting device that has a forward voltage with a magnitude dependent on an ambient parameter when driven with current; and
a power control device including:
a current generator coupled to said light emitting device and disposed to receive a control signal, said current generator being operable to convert the control signal into a driving current provided to said light emitting device, the driving current being associated with a parameter of the control signal, said current generator being further operable to provide a feedback voltage dependent on the driving current;
a compensation voltage module coupled to said light emitting device for detecting the forward voltage of said light emitting device, coupled to said current generator for detecting the feedback voltage, and disposed to receive a reference voltage, said compensation voltage module being operable to obtain a compensation voltage according to the forward voltage, the feedback voltage, and the reference voltage; and
a control signal generator coupled to said compensation voltage module for receiving the compensation voltage, and coupled to said current generator, said control signal generator being operable to generate the control signal according to the compensation voltage for provision to said current generator, the parameter of the control signal being associated with the compensation voltage.

2. The light emitting system as claimed in claim 1, wherein said light emitting device is a light emitting diode device that has the forward voltage, the ambient parameter on which the magnitude of the forward voltage is dependent being an ambient temperature.

3. The light emitting system as claimed in claim 1, wherein:
said current generator is configured such that the driving current converted from the control signal has an average magnitude proportional to the parameter of the control signal, and the feedback voltage has a magnitude proportional to a magnitude of the driving current;
said compensation voltage module is configured such that the compensation voltage has a magnitude proportional to the magnitude variation of the forward voltage; and
said control signal generator is configured such that the parameter of the control signal is inversely proportional to the magnitude of the compensation voltage.

4. The light emitting system as claimed in claim 1, wherein the control signal is a pulse signal, and the parameter of the control signal is a duty cycle of the pulse signal, the driving current converted from the control signal being a pulse current, the feedback voltage being a pulse voltage.

5. The light emitting system as claimed in claim 1, wherein said current generator includes:
an operational amplifier that has a first input for receiving the control signal, a second input, and an output;
a transistor having a first terminal coupled to said light emitting device, a second terminal coupled to said second input of said operational amplifier, and a control terminal coupled to said output of said operational amplifier;
a first resistor having a first terminal coupled to said second input of said operational amplifier, and a second terminal; and
a second resistor having a first terminal coupled to said second terminal of said first resistor, and a grounded second terminal, the feedback voltage having a magnitude that is substantially equal to a product of a magnitude of the driving current and a resistance of said second resistor.

6. The light emitting system as claimed in claim 1, said compensation voltage module includes:
a voltage detecting unit coupled to said light emitting device for detecting the forward voltage thereof, so as to obtain a first working voltage proportional to the forward voltage;
a current detecting unit coupled to said current generator for detecting the feedback voltage, so as to obtain a second working voltage proportional to an average magnitude of the driving current;
a multiplier unit coupled to said voltage detecting unit for receiving the first working voltage, and coupled to said current detecting unit for receiving the second working voltage, said multiplier unit being operable to perform multiplication operation between the first and second working voltages, so as to obtain a product voltage; and
an adder unit that is coupled to said multiplier unit for receiving the product voltage, and that receives the reference voltage, said adder unit being operable to perform addition operation between the product voltage and the reference voltage, so as to obtain the compensation voltage.

7. The light emitting system as claimed in claim 6, wherein said voltage detecting unit includes:
a voltage detector circuit including an instrumentation amplifier that has two inputs coupled respectively to two ends of said light emitting device, and an output for providing an output response proportional to the forward voltage of said light emitting device;
a voltage integrator circuit coupled to said voltage detector circuit for receiving and performing integration operation on the output response, so as to obtain an integration voltage; and
an amplifier circuit coupled to said voltage integrator circuit for receiving and amplifying the integration voltage, so as to obtain the first working voltage.

8. The light emitting system as claimed in claim 1, wherein said control signal generator includes:
a sawtooth wave circuit for generation of a sawtooth signal; and
a comparator circuit coupled to said sawtooth wave circuit for receiving the sawtooth signal, and coupled to said compensation voltage module for receiving the compensation voltage, said comparator circuit being operable to generate the control signal according to comparison of the compensation voltage and the sawtooth signal, such that the duty cycle of the control signal has an inverse relation to a magnitude of the compensation voltage.

9. A power control device adapted to control a light emitting device that has a forward voltage with a magnitude dependent on an ambient parameter when driven with current, said power control device comprising:
a current generator to be coupled to the light emitting device and disposed to receive a control signal, said current generator being operable to convert the control signal into a driving current to be provided to the light emitting device, the driving current being associated with a parameter of the control signal, said current generator being further operable to provide a feedback voltage dependent on the driving current;
a compensation voltage module to be coupled to the light emitting device for detecting the forward voltage of the light emitting device, coupled to said current generator for detecting the feedback voltage, and disposed to receive a reference voltage, said compensation voltage module being operable to obtain a compensation voltage according to the forward voltage, the feedback voltage, and the reference voltage; and
a control signal generator coupled to said compensation voltage module for receiving the compensation voltage, and coupled to said current generator, said control signal generator being operable to generate the control signal according to the compensation voltage for provision to said current generator, the parameter of the control signal being associated with the compensation voltage.

10. The power control device as claimed in claim 9, wherein:
said current generator is configured such that the driving current converted from the control signal has an average magnitude proportional to the parameter of the control signal, and the feedback voltage has a magnitude proportional to a magnitude of the driving current;
said compensation voltage module is configured such that the compensation voltage has a magnitude proportional to the magnitude variation of the forward voltage; and
said control signal generator is configured such that the parameter of the control signal is inversely proportional to the magnitude of the compensation voltage.

11. The power control device as claimed in claim 9, wherein the control signal is a pulse signal, and the parameter of the control signal is a duty cycle of the pulse signal, the driving current converted from the control signal being a pulse current, the feedback voltage being a pulse voltage.

12. The power control device as claimed in claim 9, wherein said current generator includes:
an operational amplifier having a first input that receives the control signal, a second input, and an output;
a transistor having a first terminal to be coupled to the light emitting device, a second terminal coupled to said second input of said operational amplifier, and a control terminal coupled to said output of said operational amplifier;
a first resistor having a first terminal coupled to said second input of said operational amplifier, and a second terminal; and
a second resistor having a first terminal coupled to said second terminal of said first resistor, and a grounded second terminal, the feedback voltage having a magnitude that is substantially equal to a product of a magnitude of the driving current and a resistance of said second resistor.

13. The power control device as claimed in claim 9, said compensation voltage module includes:
a voltage detecting unit to be coupled to the light emitting device for detecting the forward voltage thereof, so as to obtain a first working voltage proportional to the forward voltage;
a current detecting unit coupled to said current generator for detecting the feedback voltage, so as to obtain a second working voltage proportional to an average magnitude of the driving current;
a multiplier unit coupled to said voltage detecting unit for receiving the first working voltage, and coupled to said current detecting unit for receiving the second working voltage, said multiplier unit being operable to perform multiplication operation between the first and second working voltages, so as to obtain a product voltage; and
an adder unit that is coupled to said multiplier unit for receiving the product voltage, and that receives the reference voltage, said adder unit being operable to perform addition operation between the product voltage and the reference voltage, so as to obtain the compensation voltage.

14. The power control device as claimed in claim 13, wherein said voltage detecting unit includes:
a voltage detector circuit including an instrumentation amplifier that has two inputs coupled respectively to two ends of the light emitting device, and an output for providing an output response proportional to the forward voltage of the light emitting device;
a voltage integrator circuit coupled to said voltage detector circuit for receiving and performing integration operation on the output response, so as to obtain an integration voltage; and
an amplifier circuit coupled to said voltage integrator circuit for receiving and amplifying the integration voltage, so as to obtain the first working voltage.

15. The power control device as claimed in claim 9, wherein said control signal generator includes:
a sawtooth wave circuit for generation of a sawtooth signal; and
a comparator circuit coupled to said sawtooth wave circuit for receiving the sawtooth signal, and coupled to said compensation voltage module for receiving the compensation voltage, said comparator circuit being operable to generate the control signal according to comparison of the compensation voltage and the sawtooth signal, such that the duty cycle of the control signal has an inverse relation to a magnitude of the compensation voltage.
